(19) United States
(12) Patent Application Publication
(10) Pub. No.: US 2014/0113213 A1
(43) Pub. Date: Apr. 24, 2014

(54) POROUS OXIDE ELECTRODE LAYER AND METHOD FOR MANUFACTURING THE SAME

(71) Applicant: NATIONAL TAIWAN UNIVERSITY, Taipei (TW)

(72) Inventors: WEN-CHENG J. WEI, Taipei (TW); TING-YU LIN, Taipei (TW); SUNG-EN LIN, Taipei (TW)

(73) Assignee: National Taiwan University, Taipei (TW)

(21) Appl. No.: 13/760,278

(22) Filed: Feb. 6, 2013

(30) Foreign Application Priority Data
Oct. 23, 2012 (TW) 101139025

(51) Int. Cl. H01M 4/88

(52) U.S. Cl. CPC H01M 4/88
USPC 429/482; 427/115

(57) ABSTRACT

This invention provides a method for manufacturing porous oxide electrode layer, comprising: preparing an electrode slurry containing an electrically conductive oxide material powder, a dispersant, water and a moisture agent; spin coating the electrode slurry on a surface of a thin electrolyte or a porous substrate and simultaneously controlling the thickness and uniformity of the electrode layer on the fine electrolyte or the porous substrate; and calcining the electrode layer on the fine electrolyte or the porous substrate to form a porous electrode.

### BACKGROUND OF THE INVENTION

1. Field of the Invention

The present invention relates to porous oxide electrode layer, and more particularly, to a porous oxide electrode layer used in solid oxide fuel cells.

2. Description of the Related Art

A solid oxide fuel cell (SOFC) is an electricity-generating apparatus featuring high power conversion efficiency and low pollution; therefore, it becomes more important in recent years. The principles of operation are as follows: supply oxygen gas or air into the cathode of a SOFC; supply natural gas, hydrogen or other gaseous feuls into the anode of the SOFC; by the reduction occurring at the cathode and the oxidation occurring at the anode of the cell, electricity and gaseous waste produced from the electrochemical reactions of the fuel gases are generated. The cathode and anode structures of a SOFC are similar; both of them are porous, electrically conductive films; however, these two electrodes are the places where reduction or oxidation occur respectively, the material requirements for the two electrodes are different hence. Take the cathode of a SOFC for example, the cathode is operated in a high-temperature environment with abundant oxygen; therefore, noble metals inert to oxygen or oxide with high electric conductivity are used for manufacturing the cathode porous layer with the following five characteristics: 1. Porous: the porosity is higher than 20%. 2. Highly electrically conductive: i.e. the cathode possesses a low area specific resistance (ASR) and a low polarized resistance (Rₚₒₗ). 3. Chemically and mechanically stable in operation conditions. 4. The thermal expansion coefficient is compatible with other units of the cell. 5. Highly catalytic to the reduction of the oxygen (O₂+4e⁻→2O²⁻).

In the past, the electrically conductive oxide material used most frequently for the cathode is (La,Sr)MnO₃, abbreviated as LSM (C. C. T. Yang, W. J. Wei, and A. Roosen, “Reaction kinetics and mechanism between La_{0.65}Sr_{0.3}MnO₃ and 8 mol % yttria-stabilized zirconia,” J. Am. Ceram. Soc 87[6] 1110-16 (2004); D. Ding, M. Gong, C. Xu, N. Baxter, Y. Li, J. Zondlo, K. Gerdes, X. Liu, “Electrochemical characteristics of samaria-doped ceria infiltrated strontium-doped LaMnO₃ cathodes with varied thickness for yttria-stabilized zirconia electrolytes,” J. Power Sources 196 2551-2557 (2011)); the main reason for this popularity is the maturity of synthesizing this material and commercial concerns. Later, mixed ionic/electronic conductors (MIECs) emerge, such as (La,Sr)(Co,Fe)O₃, abbreviated as LSCF (J. M. Bae and B. C. H. Steel, Properties of LaSrCoFeO₃₋ (LSCF) double layer cathodes on gadolinium-doped cerium oxide (CGD) electrolytes, I. Role of SiO₂,” Solid State Ionics, 106, (1998) 247-253, and II. Role of oxygen exchange and diffusion,” Solid State Ionics, 106 (1998) 255-261; C. Y. Fu, C. L. Chang, C. S. Hsu, and B. W. Hwang, “Electrostatic spray deposition of LaSrCoFeO₃,” Mat. Chem. Phy., 91 (2005) 28-35), and (Ba,Sr)(Co,Fe)Oₓ, abbreviated as BSCF, which is published by the Julich research center in Germany; the experimental results of both cathode materials show promising electric conductivity. If a solid oxide fuel cell has a good power output capability, the interface between the cathode and the electrolyte of this cell usually has an area specific resistance between 0.1-0.3 Ωcm² at 700-800° C., the thickness of the cathode ranges from 8 to 50 μm. One of the structural characteristics of the SOFC cathode is similar to that of the anode, that is triple phase boundaries (TPBs) in the cathode are needed; the higher the density of TPBs, the higher the maximal power density (MPD, in W/cm²). Because of the deficiency that the LSM only has electrons for conduction, the recent researches make use of this material to form composite cathode, for example, 20SDC is added to the porous LSM cathode (D. Ding, M. Gong, C. Xu, N. Baxter, Y. Li, J. Zondlo, K. Gerdes, X. Liu, “Electrochemical characteristics of samaria-doped ceria infiltrated strontium-doped LaMnO₃ cathodes with varied thickness for yttria-stabilized zirconia electrolytes,” J. Power Sources 196 2551-2557 (2011); J. P. Wiff, K. Jono, M. Suzuki, and S. Suda, “Improved high temperature performance of La_{0.8}Sr_{0.2}MnO₃ cathode by addition of CeO₂,” J. Power Sources 196 (2011) 6196-6200), or YSZ granules are added to the cathode to increase the density of TPBs. For the composite electrode, at 800° C., the area specific resistance of the interface between the electrode and the electrolyte can be reduced as low as 0.05 Ωcm², and the output power density can even exceed 1000 mW/cm². The research from Ding et al. also indicates the optimized amount of 20SDC added for enhancing the conducting characteristic of a LSM cathode is about 50 wt %, and the thickness of this composite electrode for maximal power density is about 30 μm (electrodes with thicknesses of 10 μm, 30 μm and 50 μm were compared); if the electrode is too thin, there will not be enough TPBs for supporting a large power output, on the other hand, if the electrode is too thick, the diffusing gases will not be provided promptly, and the ohmic impedance will be higher also; this result from Ding et al. is different from the simulation by E. Ivers-Tiffee, in which a thickness of 10 μm is the optimized value.

At present, many methods have been developed to manufacture the electrodes (both anode and cathode) of solid oxide fuel cells; the generally known methods include spray coating, electrostatic spray deposition, spray printing and painting. The aforementioned manufacturing methods all have the characteristics of low cost and simple process and are suitable for electronic industries. On the other hand, for higher power efficiency and better stacking structure, other manufacturing methods such as chemical vapor deposition (CVD), plasma chemical vapor deposition (PCVD), combustion chemical vapor deposition (CCVD), or combustion spray are developed; certainly, these methods are more time-consuming, and the costs are higher; therefore, they are usually applied in research works and rarely applied in mass production.

The structure of a SOFC electrode is a porous film, and cracks are brought forth easily during the manufacturing process. The cracks reduce the current collection capability, increase the resistance and decrease the output power. Therefore, a simple and low-cost process for manufacturing porous electrodes with few cracks, good conductivity and uniform thickness is needed.

### SUMMARY OF THE INVENTION

In order to produce porous oxide electrode layer with few cracks, high conductivity and uniform thickness at low cost, this invention provides a method for manufacturing porous oxide electrode layer; the method combines colloidal dispersion, spin coating and calcinations steps; the method comprises: preparing an electrode slurry containing an electrically conductive oxide material powder, a dispersant, water and a moisture agent; spin coating the electrode slurry on a surface of a fine electrolyte layer or a porous substrate, and simultaneously controlling the thickness and uniformity of the electrode slurry on the fine electrolyte or the porous substrate; and calcining the electrode slurry on the fine electrolyte layer or the porous substrate to form a porous electrode.

To enhance the maximal power density of the solid oxide fuel cell and increase the density of triple phase boundaries, said electrode slurry can further contain yttria-stabilized zirconia (YSZ); after the steps of spin coating and calcination, the electrically conductive oxide and YSZ form composite electrode on the fine electrolyte layer or on the porous substrate.

To ameliorate the problem of the cracks incurred during manufacturing, this invention proposes to add polyethylene glycol (PEG) with a low molecular weight into the electrode slurry as a moisture agent to reduce the cracks on the fabricated electrode and lower the area specific resistance of the interface between the electrode and the electrolyte, wherein the molecular weight of the PEG ranges from 200 to 1500.

During the spin coating step, if the electrode slurry is not thick or viscous enough, the fabricated electrode will not have enough thickness even after several times of spin coating; therefore, this invention proposes to add aqueous binder to increase the viscosity of the electrode slurry, then the thickness of the fabricated electrode can be controlled during the process of this invention.

Different electrode material powders have different average particle diameters; for an electrode made from an electrode material powder with a small average particle diameter, the amount of the cracks in the fabricated electrode can be satisfactorily small even without the moisture agent added; therefore, this invention provides another similar method for manufacturing porous oxide electrode layer, comprising: preparing an electrode slurry containing an electrically conductive oxide material powder, a dispersant, water and a binder; spin coating the electrode slurry on a surface of a fine electrolyte or a porous substrate and simultaneously controlling the thickness and uniformity of the electrode slurry on the fine electrolyte or the porous substrate; and calcining the electrode slurry on the fine electrolyte or the porous substrate to form a porous electrode.

With the method for manufacturing porous oxide electrode layer provided by this invention, different electrode materials can be selected to prepare the electrode slurry for spin coating; by adjusting the solid loading of the slurry, selecting the proper binder and moisture agent, and adjusting the concentration of the binder and moisture agent in the slurry, the thickness and quality of the fabricated electrode can be controlled, and porous oxide electrodes with a uniform thickness, few cracks and low contact resistance to the electrolyte can be fabricated at low cost.

### BRIEF DESCRIPTION OF THE DRAWINGS

FIG. 1 shows the process for fabricating a composite porous oxide electrode layer provided by the present invention.

FIG. 2 shows the process for fabricating a simple porous oxide electrode layer provided by the present invention.

FIG. 3 shows the relationship between the solid loading of the water-based composite electrode slurry and the thickness of the fabricated electrode in the first embodiment of this invention.

FIG. 4 shows the scanning electron microscope (SEM) images of the surface of the electrode made from slurry sample 4 in the second embodiment of this invention, wherein FIG. 4(a) and FIG. 4(b) are images of the electrode surface with different magnifications, and FIG. 4(c) is SEM image of the cross section of the electrode as pointed.

FIG. 5(a) and FIG. 5(b) show the SEM images of the surfaces of the electrodes made from slurry samples 5 and 6 respectively in the second embodiment of this invention; FIG. 5(a′) and FIG. 5(b′) show SEM images of the cross sections of the electrodes made from slurry samples 5 and 6, respectively.

FIG. 6 shows the relationship between the spin cycles and the thickness of the fabricated composite electrode in the second embodiment of this invention with slurry sample 6.

FIG. 7 shows the relationship between the spin cycles and the thickness of the fabricated composite electrode in the third embodiment of this invention with slurry sample 8.

FIG. 8(a), FIG. 8(b) and FIG. 8(c) show the SEM images of the surfaces of the electrodes made from slurry sample 9, 10, and 11, respectively, in the third embodiment of this invention.

FIG. 9 shows the relationship between the spin cycles and the thickness of the fabricated composite electrode in the third embodiment of this invention with slurry sample 11.

FIG. 10 shows the relationship between the spin period and the thickness of the fabricated composite electrode in the fourth embodiment of this invention with slurry sample 8; FIG. 10 also shows the relationship between the spin period and the uniformity of the fabricated composite electrode.

FIG. 11 shows the relationship between the spin cycles and the thickness of the fabricated composite electrodes with slurry samples 8, 9, 11, 6 and 7.

FIG. 12(a) and FIG. 12(b) show the SEM images of the surfaces of the electrodes made from slurry samples 3 and 8, respectively; FIG. 12(a′) and FIG. 12(b′) show the schematic diagrams of the crack distribution on the surfaces of the electrodes made from slurry samples 3 and 8, respectively.

FIG. 13(a), FIG. 13(b), FIG. 13(c), FIG. 13(d), FIG. 13(e), and FIG. 13(f) show the SEM images of the surfaces of the electrodes made from slurry samples 7, 9, 10, 11, 5 and 6 respectively; FIG. 13(a′), FIG. 13(b′), FIG. 13(c′), FIG. 13(d′), FIG. 13(e′), and FIG. 13(f′) show the schematic diagrams of the crack distribution on the surfaces of the electrodes made from slurry samples 7, 9, 10, 11, 5 and 6, respectively.

FIG. 14 shows the relationship between the densities of cracks of the composite electrodes made from slurry samples 7, 6, 11, 9 and the contact resistances of the samples tested at different temperatures.

### DETAILED DESCRIPTION OF THE PREFERRED EMBODIMENTS

The detailed embodiments accompanied with the drawings will illustrate the present invention. It is to be noted that the embodiments of the present invention are exemplary and the present invention is not limited to the embodiments. The embodiments provided make the disclosure of this invention full and clear; therefore, those skilled in the related art can make and use this invention. In the embodiments of this invention, electrically conductive oxide material LSM or LSCF is selected as the major ingredient to produce the cathode for solid oxide fuel cells, the compositions of the slurry samples used are list in Table 1.

TABLE 1
The slurry samples used in the embodiments
of the present invention

| | | Solid | Carrier | PVA |
|---|---|---|---|---|
| | Simple/Composite | loading | Water:PEG200 | concentration |
| Sample | electrode material | (wt %) | (weight ratio) | (wt %) |
| 1 | LSM + YSZ | 15% | 100:0 | 0% |
| 2 | LSM + YSZ | 30% | 100:0 | 0% |
| 3 | LSM + YSZ | 50% | 100:0 | 0% |
| 4 | LSM + YSZ | 50% | 100:0 | 5% |
| 5 | LSCF + YSZ | 50% | 100:0 | 2% |
| 6 | LSCF + YSZ | 50% | 100:0 | 1% |
| 7 | LSCF + YSZ | 50% | 100:0 | 0% |
| 8 | LSM + YSZ | 50% | 0:100 | 0% |
| 9 | LSCF + YSZ | 50% | 0:100 | 0% |
| 10 | LSCF + YSZ | 50% | 10:90 | 0% |
| 11 | LSCF + YSZ | 50% | 20:80 | 0% |
| 12 | LSM | 50% | 0:100 | 0% |
| 13 | LSCF | 50% | 0:100 | 0% |

In table 1, simple electrode material means LSM or LSCF, and composite electrode material means LSM with YSZ added or LSCF with YSZ added; in the composite electrode slurry samples (i.e. samples 1˜11), the weight ratios of LSM:YSZ and the weight ratios of LSCF:YSZ are all 1:1. The LSCF material used in these embodiments is La_{0.6}Sr_{0.4}Co_{0.2}Fe_{0.8}O₃ (abbreviated as LSCF). The solid loading in table 1 means the weight percentage of the solids in the prepared slurry, which is ready for the spin coating step. The carrier in table 1 is water, polyethylene glycol with an average molecular weight around 200 (PEG200), or the mixture of the two, wherein the weight ratios of water:PEG200 in the carriers are given in table 1. The PVA concentrations given in table 1 are the weight % based on the powder mass in the prepared slurry, wherein PVA is added as binder. The method for preparing the slurry samples in this invention is demonstrated by the preparing of the water-based (water as the carrier) composite electrode slurry used in embodiment 1; the method is detailed as follows:

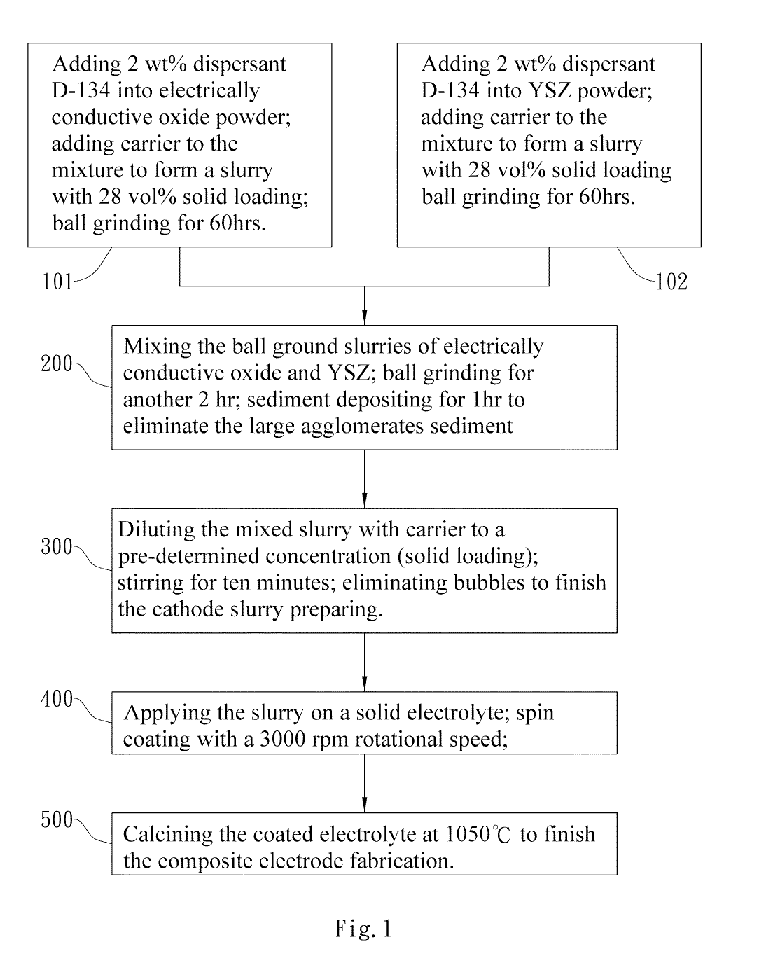

Preparing equal amounts of (La,Sr)MnO₃ (LSM, H. C. Starck Gmbh, Germany) and yttria-stabilized zirconia (YSZ, Tosoh, TZ-8Y, Japan), and adding 2 wt % D-134 (Prior Company, Taiwan) as the dispersant to the prepared LSM and YSZ, respectively; ball grinding the aforementioned mixtures respectively with a solid loading of 28 vol % for 60 hours to achieve a stable and minimal average particle diameter (FIG. 1, steps 101 and 102); mixing the two slurries and continuing the ball grinding for another two hours; sedimenting the slurry for one hour to eliminate the sediments (i.e. the large agglomerates, FIG. 1, step 200); diluting the slurry with deionized water to a predetermined concentration; stirring the diluted slurry for 10 minutes and eliminating the bubbles in the slurry to finish the preparation of the electrode slurry (FIG. 1, step 300).

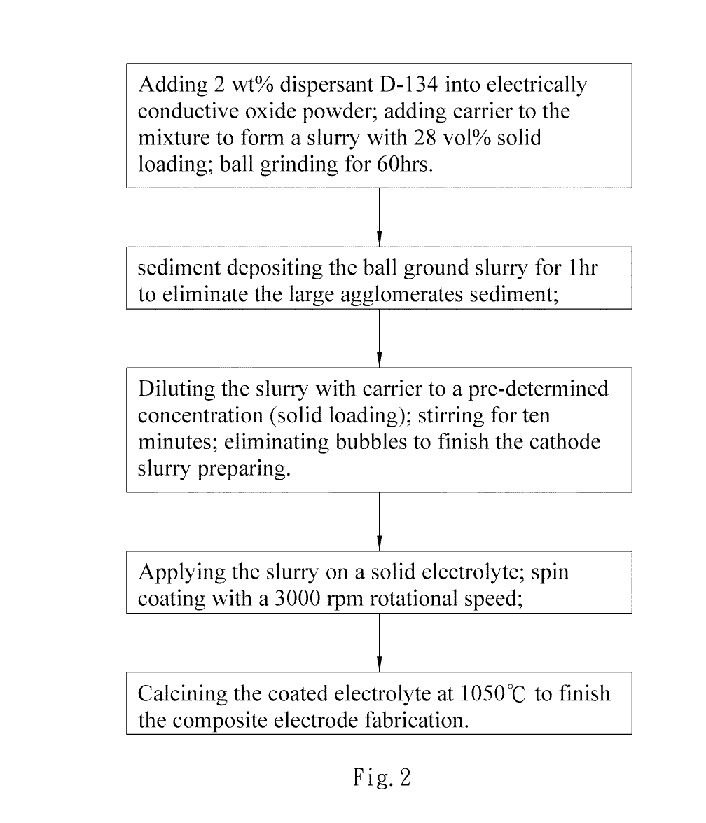

In the embodiments of this invention, after the preparation of the electrode slurry, the prepared slurry is applied on a thin solid electrolyte layer and spin-coated on the solid electrolyte with a rotational speed of 3000 rpm (FIG. 1, step 400). The spin cycles (the number of times of spin coating) and the spin period (the lasting time for each cycle) are used to control the thickness and uniformity of the slurry samples applied on the electrolyte; therefore, the thickness and uniformity of the fabricated electrode film can be controlled. At the last step, the solid electrolyte coated with the electrode slurry is calcined at a constant temperature to form an electrode film on the solid electrolyte (FIG. 1, step 500). The temperature for the calcination step is between 1000° C. to 1150° C.; the lasting time for the calcination step is affected by the calination temperature. Within the aforementioned temperature range, the lasting time for the calcination step ranges from several tens of minutes to ten hours. In the embodiments of this invention, the temperature selected for calcination is 1050° C., and the lasting time for calcination is 1 hour. Inspecting the fabricated electrode samples, some sintering effect can be observed. The flowchart of the method given in this invention for manufacturing composite electrodes is given in FIG. 1, and the flowchart of the method for manufacturing simple electrodes is similar and is given in FIG. 2.

The first embodiment of this invention is to explore the relationship between the solid loading of the slurry and the thickness of the fabricated electrode. The water-based composite electrode slurry with a 15 wt % solid loading (table 1, sample 1, deionized water as the carrier) is spin-coated on a thin solid electrolyte layer for 5 seconds with a rotational speed of 3000 rpm. The coated electrolyte is calcined at 1050° C. for one hour to form the composite electrode film on the solid electrolyte. The thickness of this made composite electrode is only about 800 nm; the reasons for this thickness are as follows: the viscosity of the water-based composite electrode is too low, and the slurry is spin-coated on a fine solid electrolyte layer; therefore, most of the deposited slurry is thrown away from the surface of the electrolyte.

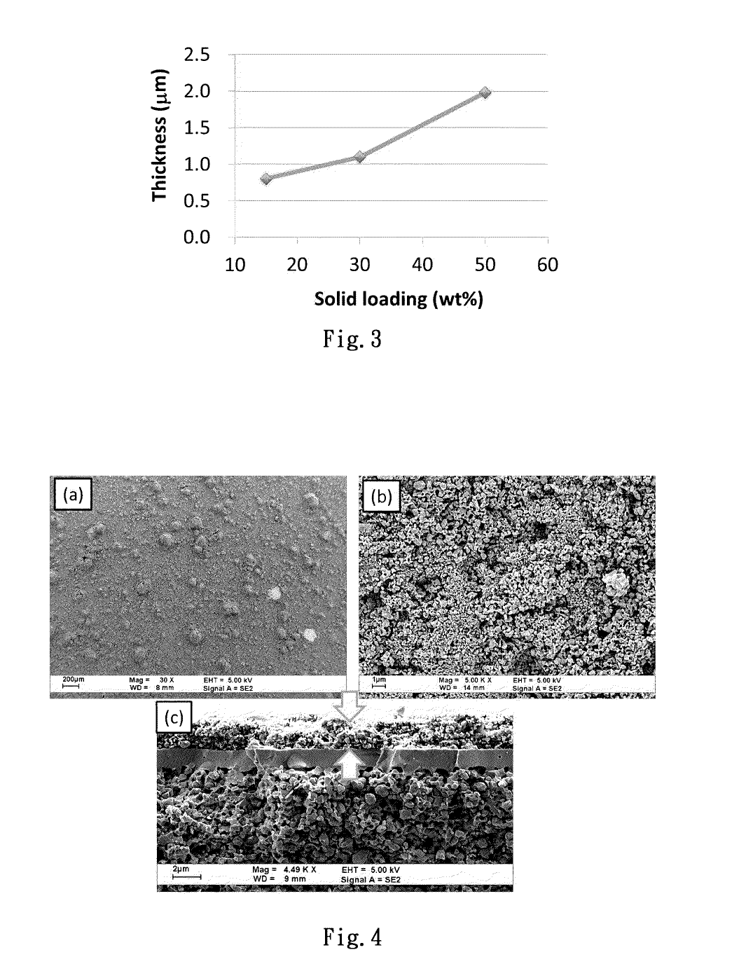

The composite electrode slurry with a 30 wt % solid loading (table 1, sample 2) is used for manufacturing the electrode with the same process, and the thickness of the fabricated composite electrode is increased obviously, the reason for the increase in thickness is the increase in the viscosity of the composite electrode slurry; on the other hand, the increase in thickness also enhances the uniformity of the fabricated composite electrode. The composite electrode slurry with a 50 wt % solid loading (table 1, sample 3) is further used for manufacturing the electrode; both the thickness and uniformity of the fabricated electrode are more satisfactory. The relationship between the thickness of the water-based composite electrode slurry and the thickness of the fabricated electrode is given in FIG. 3; the thickness of the composite electrode fabricated by this method can not exceed 5 μm.

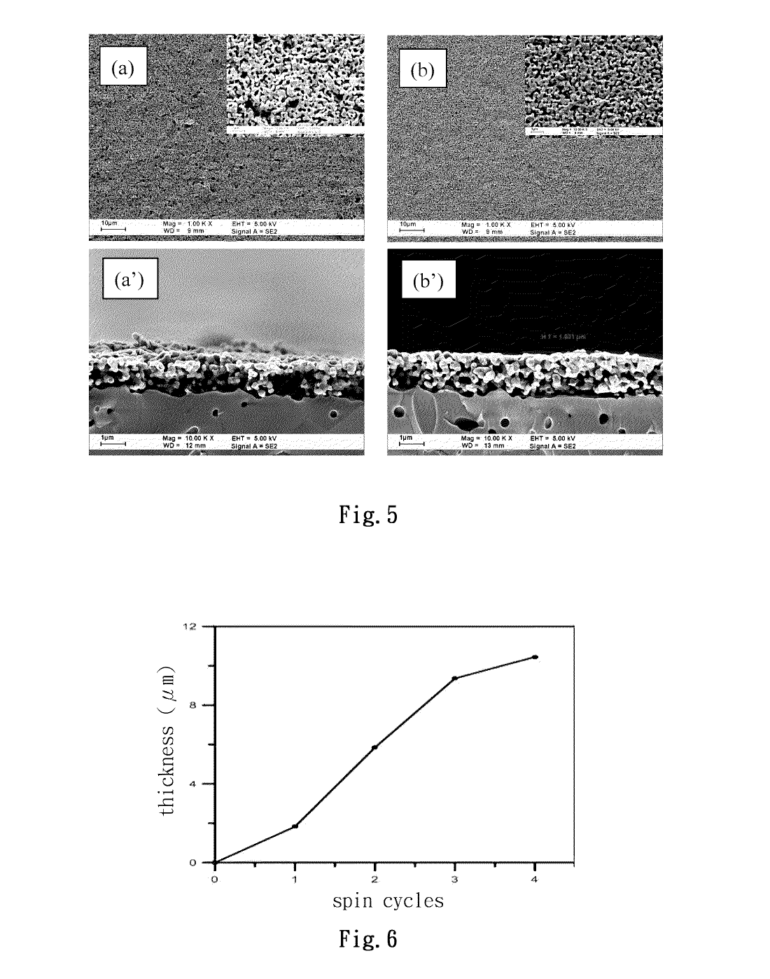

The second embodiment of this invention explores the effect of adding binder to the electrode slurry to increase the viscosity of the slurry; in this embodiment, PVA is used as the binder. Slurry sample 4 in table 1 is water-based LSM+YSZ composite electrode slurry; the solid loading of this slurry is 50 wt %, and the PVA concentration is 5 wt %. The experimental result shows the additional PVA helps to increase the thickness of the fabricated composite electrode; however, the uniformity deteriorates as shown by FIG. 4, wherein FIG. 4(a) and FIG. 4(b) are scanning electron microscope (SEM) images of the surface of the electrode made from slurry sample 4 with different magnifications, and FIG. 4(c) is the cross-sectional SEM image of the electrode. The agglomerations shown in FIG. 4(a) and FIG. 4(b) may be the result of the incompletely dissolved PVA. This embodiment also explores the effect of the additional PVA to the LSCF+YSZ composite electrode; the slurry samples used are samples 5, 6 and 7 in table 1; the solid loadings of all the three samples are 50 wt %, and the PVA concentrations are 2 wt %, 1 wt % and 0 wt %, respectively. In these LSCF+YSZ composite electrode cases, the result show reducing the amount of the PVA added ameliorate the property of the slurry; the agglomerations on the surface of the fabricated electrode can be reduced effectively with the reduction of the PVA added. When the PVA concentration is 2 wt %, there are still small agglomerations on the surface of the electrode, as shown in FIG. 5, wherein FIG. 5(a) and FIG. 5(b) are SEM images of the surfaces of the electrodes made from slurry samples 5 and 6 respectively, and FIG. 5(a′) and FIG. 5(b′) are the cross-sectional SEM images of the electrodes made from slurry samples 5 and 6, respectively.

This embodiment further explores the relationship between the spin cycles and the thickness of the fabricated composite electrode; the slurry sample used is sample 6 in table 1 (water-based LSCF+YSZ composite electrode slurry); the solid loading of this slurry is 50 wt %, and the PVA concentration is 1 wt %. The slurry is spin coated on a solid electrolyte layer for 5 seconds with a rotational speed of 3000 rpm; the calcination step is then performed, and the composite electrode film is fabricated. The experiment result shows four spin cycles are needed to achieve an expected 10 μm thickness. The relationship between the spin cycles and the thickness of the composite electrode fabricated is given in FIG. 6.

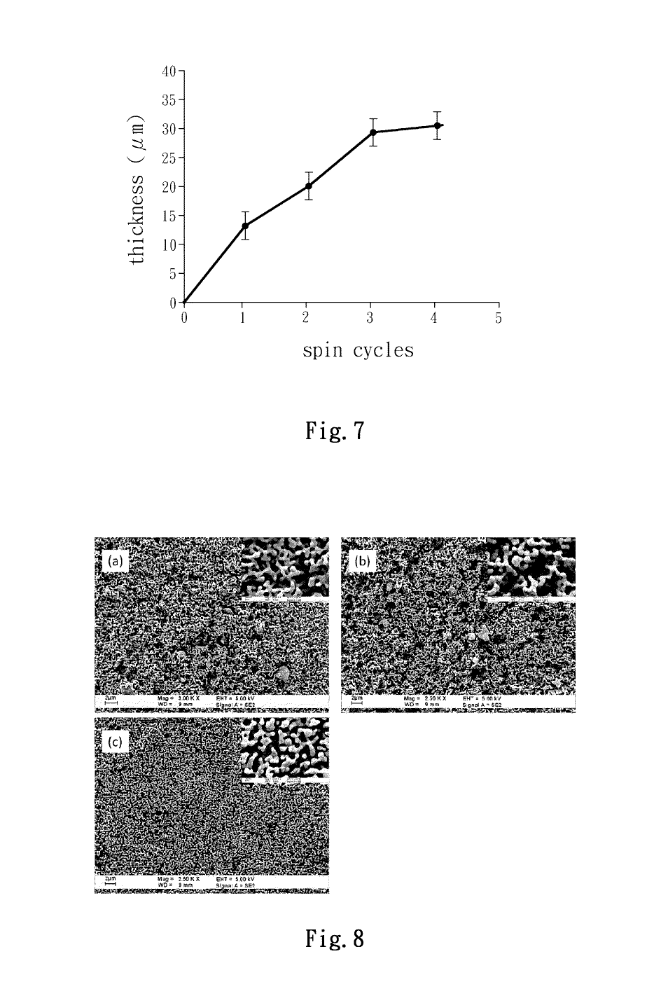

The third embodiment of this invention explores the effect to the property of the electrode by adding the moisture agent in the slurry; in this embodiment, polyethylene glycol with an average molecular weight around 200 (PEG200) is added to the electrode slurry as the moisture agent. In the first aspect of this embodiment, the slurry used is sample 8 in table 1 (PEG200 based LSM+YSZ composite electrode slurry); the solid loading of this slurry is 50 wt %, and the carrier is PEG200. The slurry is spin coated on a solid electrolyte for 5 seconds with a rotational speed of 3000 rpm; the calcinations step is then performed, and the composite electrode film is fabricated. The relationship between the spin cycles and the thickness of the composite electrode fabricated is given in FIG. 7; as shown by FIG. 7, the thickness of the composite electrode increases with the increase of spin cycles; however, four spin cycles do not bring too much difference in the thickness of the fabricated electrode to that of three spin cycles because the thickness of the coated film has been greater than 30 μm during the coating process of the fourth cycle, and the porous coated film exhibits a different slurry absorption property. The experiment result shows, using the PEG200 based (PEG200 as the carrier) LSM+YSZ composite electrode slurry, only one spin cycle is need to produce a composite electrode film thicker than 10 μm. Regarding the microstructure, composite electrodes made from water-based electrode slurry have inferior uniformity to the composite electrodes made from PEG200 based electrode slurry, and composite electrodes made from water-based electrode slurry have much more surface cracks than the electrodes made from PEG200 based composite electrode slurry.

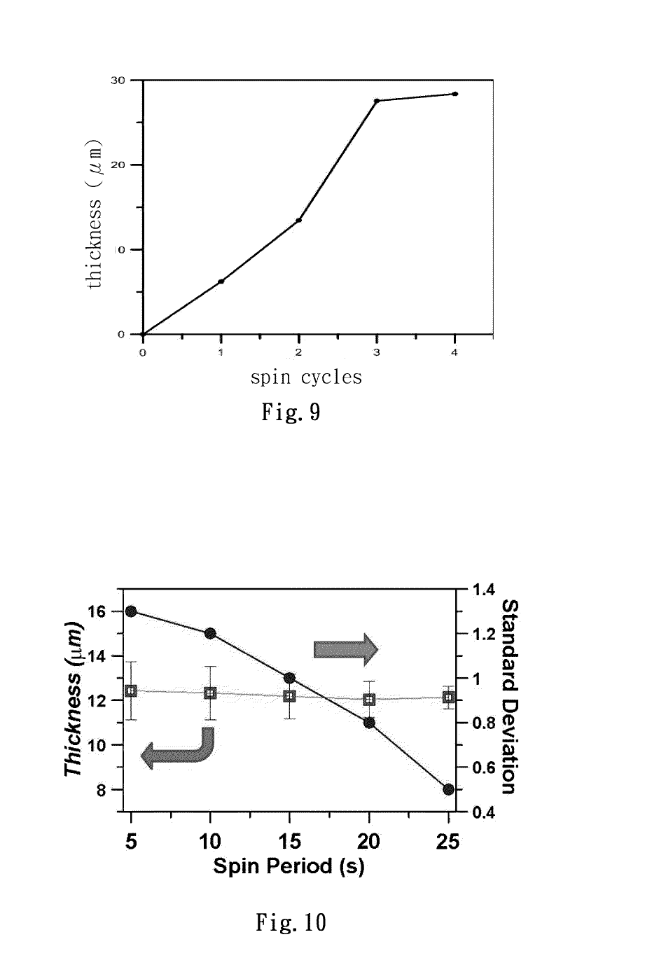

In the second aspect of this embodiment, water/PEG200 are used to prepare LSCF+YSZ composite electrode slurries. The slurry samples used are samples 9, 10, 11; the solid loadings of all the three samples are 50 wt %, the weight ratios of water:PEG200 are 0:100, 10:90, 20:80 for samples 9, 10, 11, respectively. The experiment result shows the 20:80 ratio is the best of the three, more PEG200 leads to less agglomeration on the surfaces of the electrodes fabricated, as shown in FIG. 8, wherein FIG. 8 (a), FIG. 8(b) are SEM images of the surfaces of the electrodes made from slurry samples 9 and 10, respectively, and the agglomeration effect can be observed; FIG. 8(c) is the SEM image of the surface of the electrode made from slurry samples 11, and the agglomeration effect is much lessened. Using slurry sample 11 in table 1 to manufacture LSCF+YSZ composite electrode, the thickness of the electrode fabricated with only one spin cycles is about 6.5 μm; an electrode with a thickness larger than 10 μm can thus be achieved with only two spin cycles. Therefore, adding PEG200 into the slurry helps to reduce the spin cycles. FIG. 9 shows the relationship between the spin cycles and the thickness of the fabricated composite electrode with slurry sample 11 in table 1.

The fourth embodiment of this invention explores the relationship between the spin period and the thickness of the composite electrode fabricated as well as the relationship between the spin period and the uniformity of the electrode. Slurry sample 8 in table 1 is used for manufacturing LSM+YSZ composite electrodes with only one spin cycle and various spin periods ranging from 5 to 25 seconds; the experiment result shows the thicknesses of the electrodes fabricated with different spin periods are similar (about 12 μm), and there are no obvious cracks on the surfaces of the electrodes. The relationship between the spin period and the thickness of the composite electrode fabricated is given in FIG. 10. It can be seen that there are no obvious differences between the thicknesses; however, if thicknesses of five regions on each electrode are measured to calculate the variation of the thickness of each electrode, the result shows the uniformity of the electrode is enhanced with the increase of the spin period; this result is also given in FIG. 10. The enhanced uniformity of the electrodes with a longer spin period can also be observed with other slurry samples listed in table 1.

In the fifth embodiment of this invention, slurry samples 12 and 13 in table 1 are used to manufacture simple LSM or LSCF electrode. In this embodiment, the carriers of the two slurry samples are PEG200; the solid loadings of the two slurry samples are 50 wt %, and the electrodes are made with only one spin cycle. The result shows the thicknesses of the simple electrodes are about 13 μm, which is similar to the thicknesses of the composite electrodes made from PEG200 based composite electrode slurries.

Based on the electrode films fabricated in the embodiments of this invention, the following properties of the made electrode layerafter the manufacturing process of the electrodes fabricated are discussed: 1. The spin cycles and the control of the electrode thickness; 2. The crack density on the surface of the electrode; 3. The contact resistance between the electrode and the solid electrolyte; 4. The porosity of the electrode. The discussions are as follows:

### The Spin Cycles and the Control of the Electrode Thickness:

Regarding the spin cycles and the control of the electrode thickness, all the samples observed are electrodes made from composite electrode slurries with 50 wt % solid loading. The effects of the moisture agent in the carrier and the binder concentration in the slurry are investigated; the samples observed are listed in table 2:

TABLE 2
The slurry samples used in the discussion of the spin
cycles and the control of the electrode thickness

| | Composite | Solid | Carrier | PVA |
|---|---|---|---|---|
| | electrode | loading | Water:PEG200 | concentration |
| Sample | material | (wt %) | (weight ratio) | (wt %) |
| 8 | LSM + YSZ | 50% | 0:100 | 0% |
| 9 | LSCF + YSZ | 50% | 0:100 | 0% |
| 11 | LSCF + YSZ | 50% | 20:80 | 0% |
| 6 | LSCF + YSZ | 50% | 100:0 | 1% |
| 7 | LSCF + YSZ | 50% | 100:0 | 0% |

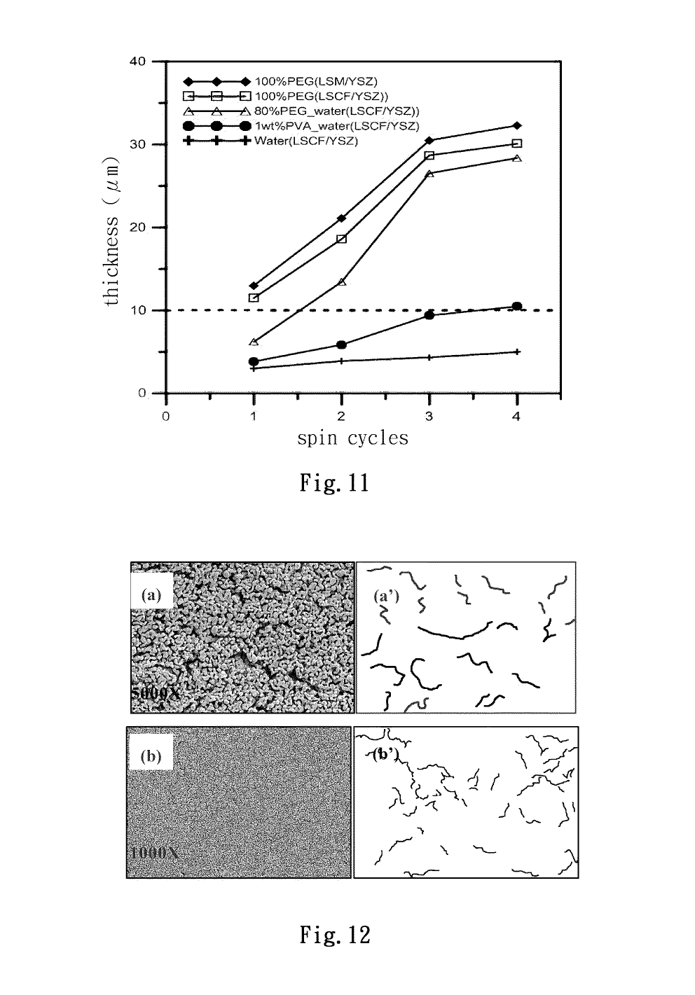

The relationship between the spin cycles and the thicknesses of the electrode made from these slurry samples is shown in FIG. 11; the result shows the addition of PEG200 helps to increase the deposition rate (μm/cycle) of the electrode effectively, generally 1 or 2 spin cycles can achieve a 10 μm satisfactory electrode thickness. On the other hand, in the water-based composite electrode slurry cases, even with the binder PVA added, 3 to 4 spin cycles are needed to achieve a satisfactory 10 μm electrode thickness. Besides the deposition rate, another character should be taken into consideration is the stability of the multiple spin coating process, i.e. if the thickness increase of each spin cycle is constant. In the first spin cycle, the substrate is a fine and smooth 8YSZ electrolyte layer, and the thickness increase of this cycle is pronounced; however, in the third or fourth spin cycle, the substrate becomes porous; the slurry is partially adsorbed by the underneath layer, and the additional thickness ceases gradually in the following cycle.

### The Crack Density on the Surface of the Electrode:

Regarding the electrode crack density analysis, all the samples observed are electrodes made from composite electrode slurries with 50 wt % solid loading. The effects of the moisture agent in the carrier and the binder concentration in the slurry are investigated; the samples observed are listed in table 3:

TABLE 3
The slurry samples used in the discussion
of the electrode crack density

| | | | | PVA | |
|---|---|---|---|---|---|
| | Composite | Solid | Carrier | concen- | Crack |
| | electrode | loading | Water:PEG200 | tration | density |
| Sample | material | (wt %) | (weight ratio) | (wt %) | (μm/μm²) |
| 3 | LSM + YSZ | 50% | 100:0 | 0% | 47 × 10⁻³ |
| 8 | LSM + YSZ | 50% | 0:100 | 0% | 14 × 10⁻³ |
| 7 | LSCF + YSZ | 50% | 100:0 | 0% | 7 × 10⁻⁴ |
| 9 | LSCF + YSZ | 50% | 0:100 | 0% | 80 × 10⁻⁴ |
| 10 | LSCF + YSZ | 50% | 10:90 | 0% | 30 × 10⁻⁴ |
| 11 | LSCF + YSZ | 50% | 20:80 | 0% | 20 × 10⁻⁴ |
| 5 | LSCF + YSZ | 50% | 100:0 | 2% | 10 × 10⁻⁴ |
| 6 | LSCF + YSZ | 50% | 100:0 | 1% | 6 × 10⁻⁴ |

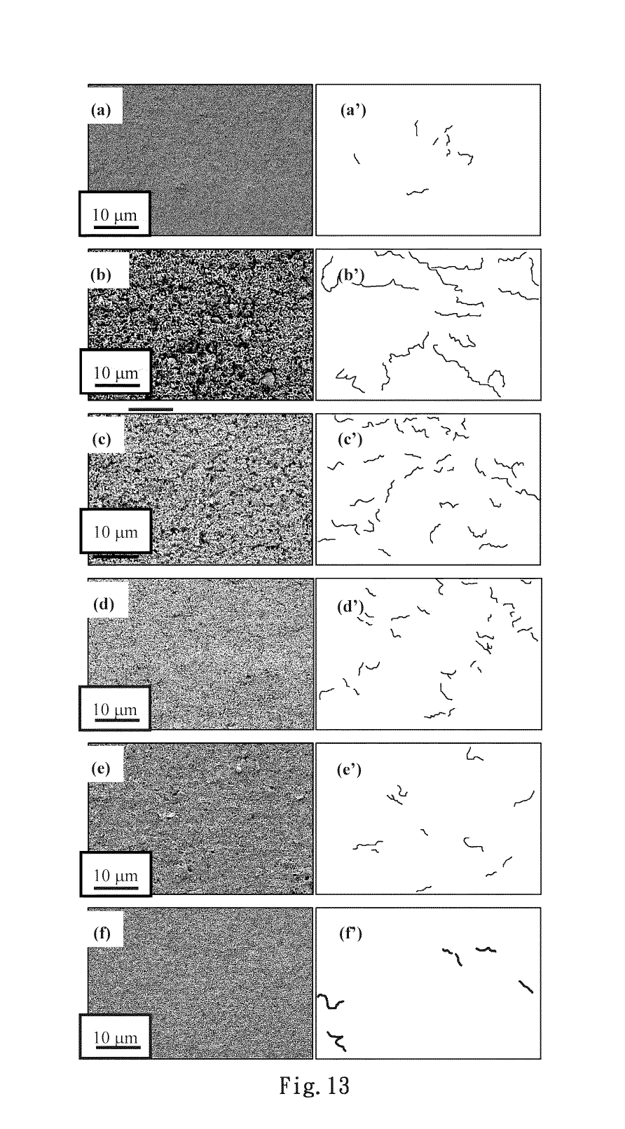

The method of this analysis is detailed as follows: The surfaces of the electrode manufactured by the process of this invention are photographed by a scanning electron microscope (SEM); the cracks on the electrode surfaces are mapped and redrawn from these SEM images. The image analysis software “Image-pro®” is then used to calculate the total length of the cracks on a surface of an electrode, and the crack density (unit: μm/μm²) of each electrode surface can be calculated and used to assess the quality of the electrode; the crack densities of the electrode samples observed are also given in table 3. The surface SEM images of the electrodes made from slurry samples 3 and 8 are given in FIG. 12(a) and FIG. 12(b), respectively and the corresponding crack distributions are given in FIG. 12(a′) and FIG. 12(b′). The surface SEM images of the electrodes made from slurry samples 7, 9, 10, 11, 5, and 6 are given in FIG. 13(a), FIG. 13(b), FIG. 13(c), FIG. 13(d), FIG. 13(e), and FIG. 13(f), respectively and the corresponding crack distributions are given in FIG. 13(a′), FIG. 13(b′), FIG. 13(c′), FIG. 13(d′), FIG. 13(e′), and FIG. 13(f′).

Because the average particle diameter of LSM powder is relatively big (D₅₀=1.5 μm), the crack densities on the surfaces of the LSM+YSZ composite electrodes are higher than the crack densities on the surfaces of the LSCF+YSZ composite electrodes; it should be noted that the average particle diameter of LSCF6428 powder is much smaller (D₅₀=0.1 μm). The crack density of the electrode made from water-based LSM+YSZ composite electrode slurry is 47×10⁻³ μm/μm², while the crack density of the electrode made from PEG200-based LSM+YSZ composite electrode slurry is reduced to 14×10⁻³ μm/μm².

As stated above, the average particle diameter of LSCF powder is small; therefore, even without the addition of PEG200, the crack density of the electrode made from water-based LSCF+YSZ slurry is low (sample 7 in table 3, the crack density is only 7×10⁻⁴ μm/μm²). The experiment result also shows in the case where PEG200 is added to the LSCF+YSZ composite electrode slurry, if the weight ratio of PEG200:water exceeds 80:20, the agglomeration phenomenon occurs, which leads to more cracks and higher porosity. Therefore, it is suggested to keep the weight ratio of PEG200:water at 80:20 in the manufacture of the LSCF+YSZ composite electrode, and an electrode with a relatively smooth surface and less cracks can then be fabricated (sample 11 in table 3, the crack density is only 20×10⁻⁴ μm/μm²). Regarding the additional PVA as binder to increase the viscosity of the slurry, when the PVA concentration is higher than 2 wt %, agglomeration phenomenon can be observed; therefore, it is suggested to control the PVA concentration at 1 wt % (sample 6 in table 3, the crack density is 6×10⁻⁴ μm/μm²).

### The Contact Resistance Between the Electrode and the Solid Electrolyte:

Regarding the analysis of the contact resistance between the electrode and the solid electrolyte (abbreviated as contact resistance), the samples observed are electrodes made from LSCF+YSZ composite electrode slurries, and the solid loadings of these slurries are 50 wt % (samples 7, 6, 11, and 9 in table 1). This electrochemical property is analyzed as follows: AC-impedance technique is adopted to measure the Electrochemical Impedance Spectroscopy (EIS) of different half cells, and by the ohmic resistance measured, the area specific resistance of the contact resistance can be calculated. The contact resistances between the composite electrodes and the electrolytes at different temperatures are given in table 4; the crack densities of the electrodes are also given in table 4.

TABLE 4
The contact resistances (unit: Ωcm²) at different temperatures

| Electrode sample | Sample 7 | Sample 6 | Sample 11 | Sample 9 |
|---|---|---|---|---|
| ASR at 600° C. | 0.48 | 0.44 | 0.64 | 1.27 |
| ASR at 650° C. | 0.41 | 0.37 | 0.57 | 1.08 |
| ASR at 700° C. | 0.37 | 0.35 | 0.50 | 0.96 |
| ASR at750° C. | 0.26 | 0.23 | 0.44 | 0.79 |
| ASR at 800° C. | 0.19 | 0.18 | 0.32 | 0.66 |
| Crack density | 7 × 10⁻⁴ | 6 × 10⁻⁴ | 20 × 10⁻⁴ | 80 × 10⁻⁴ |
| (μm/μm²) | | | | |

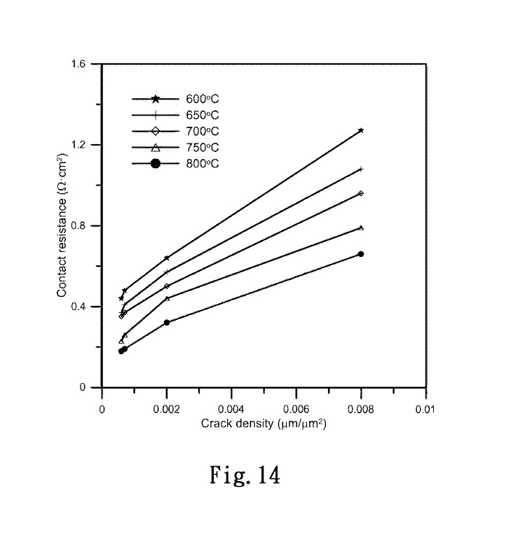

From the data shown in table 4, it can be seen that the contact resistances decrease as the temperature goes high; besides, it is obvious that high crack density leads to high contact resistance; the crack density versus contact resistance graph is given in FIG. 14, and the correlation can be observed.

### The Porosity of the Electrode:

The porosities of the electrodes made from slurry samples listed in table 3 are given in table 5, wherein, the porosities of the LSM+YSZ composite electrodes fabricated by the process of this invention are about 36%, and the porosities of the LSCF+YSZ composite electrodes fabricated by the process of this invention ranges from 29% to 42%.

TABLE 5
The slurry samples used in the discussion of the electrode porosity

| | | | | PVA | |
|---|---|---|---|---|---|
| | Composite | Solid | Carrier | concen- | |
| | electrode | loading | Water:PEG200 | tration | Porosity |
| Sample | material | (wt %) | (weight ratio) | (wt %) | (%) |
| 3 | LSM + YSZ | 50% | 100:0 | 0% | 36% |
| 8 | LSM + YSZ | 50% | 0:100 | 0% | 36% |
| 7 | LSCF + YSZ | 50% | 100:0 | 0% | 29% |
| 9 | LSCF + YSZ | 50% | 0:100 | 0% | 42% |
| 10 | LSCF + YSZ | 50% | 10:90 | 0% | 39% |
| 11 | LSCF + YSZ | 50% | 20:80 | 0% | 36% |
| 5 | LSCF + YSZ | 50% | 100:0 | 2% | 32% |
| 6 | LSCF + YSZ | 50% | 100:0 | 1% | 31% |

From the embodiments and the above discussion, it can be concluded that with the method for manufacturing porous oxide electrode layer provided in this invention, the solid loading of the slurry, the weight ratio of water:moisture agent in the carrier of the slurry and the concentration of the binder in the slurry can be adjusted with respect to different electrode materials to control the thicknesses of electrodes fabricated and the spin cycles. On the other hand, the slurry compositions also affect the properties of the electrodes directly, such as the cracks of the electrode and the contact resistance. Finally, the spin period can be used to control the uniformity of the electrode. Therefore, this invention provides a method for manufacturing porous oxide electrode layer; different electrodes materials can be selected; solid loading of the slurry, the binder, the moisture agent, and the composition of the slurry can be adjusted with respect to the electrode material selected in order to control the thickness and quality of the electrode fabricated.

What is claimed is:

1. A method for manufacturing porous oxide electrode layer, comprising:
preparing an electrode slurry containing an electrically conductive oxide material powder, a dispersant, water and a moisture agent;
spin coating the electrode slurry on a surface of a thin electrolyte layer or a porous substrate and simultaneously controlling the thickness of the electrode slurry on the electrolyte or the porous substrate; and
calcining the electrode layer on the electrolyte or the porous substrate to form a porous electrode.

2. The method for manufacturing porous oxide electrode layer according to claim 1, wherein the electrode slurry further comprises yttria-stabilized zirconia.

3. The method for manufacturing porous oxide electrode layer according to claim 1, wherein the dispersant is anionic dispersing agent.

4. The method for manufacturing porous oxide electrode layer according to claim 1, wherein the moisture agent is polyethylene glycol with a molecular weight ranging from 200 to 1500.

5. The method for manufacturing porous oxide electrode layer according to claim 1, wherein the electrode slurry further comprises a binder.

6. The method for manufacturing porous oxide electrode layer according to claim 2, wherein the dispersant is anionic dispersing agent.

7. The method for manufacturing porous oxide electrode layer according to claim 2, wherein the moisture agent is polyethylene glycol with a molecular weight ranging from 200 to 1500.

8. The method for manufacturing porous oxide electrode layer according to claim 2, wherein the electrode slurry further comprises a binder.

9. A method for manufacturing porous oxide electrode layer, comprising:
preparing an electrode slurry containing an electrically conductive oxide material powder, a dispersant, water and a binder;
spin coating the electrode slurry on a surface of a thin electrolyte or a porous substrate and simultaneously controlling the thickness of the electrode layer on the electrolyte or the porous substrate; and
calcining the electrode layer on the electrolyte or the porous substrate to form a porous electrode.

10. The method for manufacturing porous oxide electrode layer according to claim 9, wherein the electrode slurry further comprises yttria-stabilized zirconia.

11. The method for manufacturing porous oxide electrode layer according to claim 9, wherein the dispersant is anionic dispersing agent.

12. The method for manufacturing porous oxide electrode layer according to claim 9, wherein the binder is aqueous binder.

13. The method for manufacturing porous oxide electrode layer according to claim 10, wherein the dispersant is anionic dispersing agent.

14. The method for manufacturing porous oxide electrode layer according to claim 10, wherein the binder is aqueous binder.

15. A porous oxide electrode layer used in solid oxide fuel cells, comprises an electrically conductive oxide, wherein the porous oxide electrode layer is a porous film positioned on a surface of a solid electrolyte, and the crack density is lower than 10×10⁻⁴ μm/μm².

16. A porous oxide electrode layer used in solid oxide fuel cells according to claim 15, wherein the porosity of the porous oxide electrode layer ranges from 29% to 42%.

17. A porous oxide electrode layer used in solid oxide fuel cells according to claim 15, wherein the thickness of the porous oxide electrode layer ranges from 2 μm to 50 μm.
